(19) United States
(12) Patent Application Publication
(10) Pub. No.: US 2024/0039967 A1
(43) Pub. Date: Feb. 1, 2024

(54) METHOD FOR PROCESSING A REGISTRATION REQUEST FROM A TERMINAL OF A COMMUNICATION NETWORK USER, METHOD FOR PROVIDING A TABLE OF EMERGENCY NUMBERS, METHOD FOR MANAGING A TABLE OF EMERGENCY NUMBERS, DEVICES, LOCAL FACILITY, CONTROL FACILITY, FACILITY FOR MANAGING THE MOBILITY OF A USER TERMINAL, AND CORRESPONDING SYSTEM AND COMPUTER PROGRAMS

(71) Applicant: Orange, Issy-Les-Moulineaux (FR)

(72) Inventors: José DOREE, Chatillon Cedex (FR); Mickaël ALLAIN, Chatillon Cedex (FR)

(21) Appl. No.: 18/258,537

(22) PCT Filed: Dec. 20, 2021
(86) PCT No.: PCT/FR2021/052402

§ 371 Date: Jun. 20, 2023

(30) Foreign Application Priority Data
Dec. 21, 2020 (FR) FR2013828

(51) Int. Cl. H04L 65/1073; H04L 65/1016; H04L 65/1104

(52) U.S. Cl. CPC H04L 65/1073; H04L 65/1016; H04L 65/1104

(57) ABSTRACT

A method for processing a registration request from a user terminal of a communication network, referred to as home network, the home network being configured to provide multimedia services to the terminal, the terminal being attached to another communication network, referred to as visited network, interconnected with the home network. The method is implemented in a local facility of the home network and includes: upon receiving a registration request from the terminal of the user, the registration request having been transmitted by the visited network, obtaining from an emergency number table of the visited network, the table associating, with an emergency number local to the visited network, a uniform resource identifier corresponding to the number, and the emergency number table received from the visited network by the home network following reception of the registration request or a previous registration request from a user terminal attached to the visited network.

### CROSS-REFERENCE TO RELATED APPLICATIONS

This application is filed under 35 U.S.C. § 371 as the U.S. National phase of application No. PCT/FR2021/052402 entitled “METHOD FOR PROCESSING A REGISTRATION REQUEST FROM A TERMINAL OF A COMMUNICATION NETWORK USER, METHOD FOR PROVIDING A TABLE OF EMERGENCY NUMBERS, METHOD FOR MANAGING A TABLE OF EMERGENCY NUMBERS, DEVICES, LOCAL FACILITY, CONTROL FACILITY, FACILITY FOR MANAGING THE MOBILITY OF A USER TERMINAL, AND CORRESPONDING SYSTEM AND COMPUTER PROGRAMS” and filed Dec. 20, 2021, and which claims priority to FR 2013828 filed Dec. 21, 2020, each of which is incorporated by reference in its entirety.

### BACKGROUND

### Field

The field of the development is that of a communication network, configured to provide multimedia services over IP, such as Voice over IP (VoIP). For example, such a network has a standardised IMS (IP Multimedia Systems) architecture.

In particular, the development relates to the management of a table of emergency telephone numbers local to a communication network other than that of a user terminal, referred to as visited network, by the communication network of this user, referred to as home network.

### Description of the Related Art

In a mobile communication network implementing an IMS architecture, as defined by 3GPP (3rd Generation Partnership Project), ETSI and IETF, and based on the Session Initiation Protocol (SIP) for the initialisation of multimedia sessions used by videoconferencing or VoIP, different techniques are known enabling a user of this network to access a multimedia service provided by this network, when they are in a mobile situation (or roaming) and have attached themself to another mobile communication network.

For example, within a mobile phone network implementing the 3GPP LTE (Long Term Evolution) standard, one of these network interconnection techniques, referred to as “S8hr” (S8 home routing) mode, is becoming more widespread.

FIG. 1 diagrammatically shows an example of an interconnection architecture of two communication networks implementing this “S8hr” technique, which is for example described in the document IR.65—IMS Roaming, Interconnection and Interworking Guidelines published by the international association GSMA (Global System for Mobile Communications Association) on 2 Dec. 2020.

On the right, it shows a Home Public Land Mobile Network (HPLMN) to which a user of a terminal UE-A subscribes and which will be referred to in the following as the home network of this user, and on the left, another Visited Public Land Mobile Network (VPLMN) communication network, interconnected to the HPLMN home network to which the terminal UE-A is attached in a mobile situation. In the following, this second VPLMN network will be referred to as visited network. For example, the terminal UE-A wishes to establish a voice over IP communication with a UE-B terminal.

According to this “58 hr” technique, referred to as routing to the home network, all the flows linked to the execution of a multimedia service for this user UE-A in a mobile situation, whether they are signalling flows or multimedia data streams, terminate in the home network. In particular, the IMS signalling flows are routed between the visited network and the home network via an IP Exchange Network (IPX) interface, in accordance with an interconnection model defined and specified by the GSMA. This is the same interface designated in a standard manner by S8 as the one used for multimedia data traffic between a Serving Gateway (SGW) of the visited network and a Packet Data Network (PDN) Gateway (PGW), which provides a single entry point for routing IP data streams to the IMS of the home network.

In other words, the way in which the terminal UE-A is connected to the IMS of its home network follows the same principle as that used for Internet data traffic (all traffic remains processed in the home network), which simplifies deployment and therefore explains the popularity of this technique with mobile communication network operators.

However, this interconnection technique has its drawbacks.

One of them is related to the handling of emergency calls.

Indeed, emergency calls, by nature, are always handled by services (police, fire brigade, ambulance, etc.) located in the visited VPLMN network.

In the case where the telephone number dialed by the terminal of the user is internationally recognised as an emergency call (for example: 112, the emergency number accessible throughout the European Union or 911 for North America), the terminal of the user is configured to implement a specific procedure for attachment to the visited network via an emergency connection. The IP data streams are therefore not processed according to the architecture of FIG. 1, but the emergency call is fully processed in the VPLMN visited network.

However, there are emergency telephone numbers that are not recognised as such by mobile terminals. This is particularly the case with short codes, referred to as local. For example, in France, the following local emergency numbers are used: 15 (medical emergencies or ambulance), 17 (police interventions), 18 (firefighting), 115 (social emergencies or SAMU social), etc.

In a known manner, when a user's mobile terminal is located in its HPLMN home network, the standardised procedure for establishing an emergency call is as follows:
1. The mobile terminal dials a local number (e.g. 15) and requests to establish a voice call with the associated emergency service (medical emergencies), without this call being detected as an emergency call by the terminal;
2. The HPLMN home network detects that this is a local emergency number, and returns a SIP 380 response indicating to establish an “Emergency” connection with a destination retranslated in the form of a URN (Uniform Resource Name) uniform resource identifier. This URN identifier identifies a location of the resource concerned that is accessible from any communication network. For example, the resource identifier associated with local emergency number 15 is “urn:service:sos.ambulance”;
3. The mobile terminal retransmits its communication establishment request with the received URN resource identifier; and
4. The nominal network HPLMN routes this call with the priority rules and routing that apply to an emergency call of this type.

As these local numbers are not referenced in the international nomenclature, they therefore only have a meaning local to the communication network in which they are defined (which can be the HPLMN home network or the VPLMN visited network).

As a result, when the mobile terminal is in a mobile situation in a visited network connected to the terminal's home network according to the S8hr interconnection technique just presented, these local telephone numbers are not interpreted as emergency numbers by the mobile terminal and therefore cannot be treated as such by the HPLMN home network.

In particular, the proper operation of step 2 above requires that the home network recognises that the emergency number dialed from the visited network is an emergency number of said visited network.

In the state of the art, the recommended solution consists in statically configuring all the local emergency numbers of all the national networks with which the home network can interconnect, and then associate their transcription into a format that can be used by the home network, such as a URN uniform resource identifier.

This technique is obviously very cumbersome due to the large number of communication network operators in the world. The correspondence tables between local numbers and standardised identifiers are very complex to maintain over time, particularly for adding new numbers, deleting obsolete numbers, adding new operators, etc. In addition, such a static configuration is prone to errors, for example when entering correspondences between numbers and URN uniform resource identifiers, operator codes, etc.

There is therefore a need for a more effective solution that avoids the disadvantages outlined above.

The development improves the situation.

### SUMMARY

The development responds to this need by proposing a method for processing a registration request from a user terminal of a communication network, referred to as home network, said home network being configured to provide multimedia services to said terminal, said terminal being attached to another communication network, referred to as visited network and is interconnected with the home network.

Said method is implemented at a local facility of the home network and comprises:
on reception of a registration request from the terminal of the user, said registration request having been transmitted by the visited network, obtaining an emergency number table of the visited network, said table associating with at least one emergency number local to the visited network a uniform resource identifier, and
said emergency number table was received from the visited network by the home network following reception of said registration request or a previous registration request from a user terminal attached to the visited network.

A “uniform resource identifier” means an identifier unique in time and space for said resource, such as a URN identifier as mentioned above.

When a user terminal of a home network is in a mobile situation in a visited network interconnected with the home network and requests to establish a multimedia communication, this communication is managed by its home network, which receives, from the visited network, a request to register the terminal. With the development, the home network dynamically obtains from the visited network an emergency number table local to the visited network.

The development is thus based on a completely new and inventive approach to the management of emergency calls for a user terminal in a mobile situation in a visited network, which consists of the home network dynamically obtaining from the visited network a table of correspondence between local emergency numbers in force in this visited network and uniform resource identifiers accessible from any other communication network. In this way, the home network has the information necessary to send back to a mobile terminal of the user the information necessary to establish an emergency call in the visited network, without any prior static configuration of the specific (in other words, local) emergency numbers for this visited network being required. This improves the handling of emergency calls from terminals in mobile situations. Another advantage of the development is that it reuses interfaces and techniques known from current or future communications networks, which are standardised or in the process of being standardised.

The development is particularly, but not exclusively, applicable to the case where the visited network and the home network interconnect in an “S8hr” connection mode, whereby the multimedia signalling streams are carried on the same channel as the data streams.

However, the scope of the development is not limited to this example, but extends to any other interconnection architecture between the home network and the visited network in which the terminal of the user data streams terminate in the home network. For example, it also has an application in the context of 5th generation or 5G communication networks within a 5GC core network architecture, whereby the multimedia signalling flows of a mobile user terminal in a visited network are routed into its home network via an N9 interface connecting the two networks and the data streams via an N16 interface connecting the two networks.

According to one aspect of the development, obtaining comprises sending a request for transmission of the emergency number table to a control facility of the home network for relaying to the visited network, said control facility being configured to manage network resources provided for the terminal of the user, and receiving a response comprising said table.

One advantage is that the local facility does not have to manage exchanges with the visited network, this responsibility being left to another facility in the home network, namely the control facility. Another advantage is that it obtains an up-to-date emergency number table.

According to another aspect of the development, the method further comprises:
upon reception of an identifier from the visited network, checking that a said emergency number table is already available in the home network for that identifier; and
the transmission request is sent when no emergency number table is available or when the available emergency number table is associated with an out-of-date validity indicator.

An advantage is that a request is sent to the visited network only when necessary.

This saves bandwidth resources while ensuring that the emergency number table of the visited network is not out of date.

According to yet another aspect of the development, said request for transmission of the emergency number table is transmitted in a message comprising the identifier of the visited network.

For example, the message in question is a Diameter AAR request for information including the identifier of the visited network and the request is included in a dedicated action, e.g. “Emergency number table”.

According to another aspect of the development, the request for transmission of the emergency number table is inserted in a request message for obtaining the identifier of the visited network, said message being transmitted following reception of the registration request of the terminal of the user by the local facility.

According to this mode of implementation, the local facility systematically and in an anticipated manner requests the emergency number table of the network visited by the terminal of the user. One advantage is that the operations to be carried out on this facility are simplified. Reusing a signalling message which is in any case transmitted to the control facility of the network resources available to the terminal enables the resources mobilised by the signalling to be optimised.

Advantageously, on reception of a response from the control facility, said response comprising said table, the method comprises a step of storing said table in a local or remote memory of the home network.

The development also relates to a computer program product comprising program code instructions for implementing a processing method according to the development, as described previously, when it is executed by a processor.

The development also relates to a computer-readable storage medium on which the computer programs as described above are recorded.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be streamed in particular on a network, for example the Internet network.

Alternatively, the storage medium can be an integrated circuit in which the program is embedded, the circuit being adapted to execute or to be used in the execution of the above-mentioned processing method.

The development also relates to a device for processing a registration request from a user terminal of a communication network, referred to as home network, said home network being configured to provide multimedia services to said terminal, said terminal being attached to another communication network, referred to as visited network, interconnected with the home network.

Said device is configured to implement at a local facility of the home network:
on reception of a registration request from the terminal of the user, said registration request having been transmitted by the visited network, obtaining an emergency number table of the visited network, said table associating with at least one emergency number local to the visited network a uniform resource identifier, and
said emergency number table was received from the visited network by the home network following reception of said registration request or a previous registration request from a user terminal attached to the visited network.

Advantageously, said device is configured to implement the above-mentioned processing method, according to its different embodiments.

Advantageously, said device is integrated into a local facility of the home network. The above-mentioned corresponding local facility, processing device and computer program have at least the same advantages as those provided by the above-mentioned processing method according to the different embodiments of the present development.

Correspondingly, the development also relates to a method for providing, by a communication network of a terminal of the user, referred to as home network, an emergency number table (EL) of another communication network, referred to as visited network, to which said terminal is attached, said table associating to emergency telephone numbers local to the visited network, uniform resource identifiers corresponding to said numbers.

The method is implemented in the home network by a control facility of network resources provided for the terminal and comprises:
obtaining said emergency number table in a signalling message received from the visited network following the attachment of the terminal of the user; and
transmitting said emergency number table to a local facility of the home network.

With the development, it is the control facility that directly obtains the emergency number table of the visited network. An advantage is that this table is passed through interfaces typically used by this control facility, typically to process a network session establishment request from a terminal of the user from the visited network.

According to one aspect of the development, said signalling message received from the visited network further comprises a request for the creation of a session for the terminal of the user.

Advantageously, the emergency number table has been inserted by the home network in the signalling message comprising the request for the creation of a Diameter session for the terminal of the user following the reception by the visited network of its attachment request, which makes it possible to pool the same message intended for the control facility of the home network.

No query from the home network is therefore required to obtain this table. The signalling is therefore optimised.

According to another aspect of the development, the method comprises, upon reception of a request from a local facility of the home network, transmitting said table to said local facility.

An advantage is that in this embodiment, the home network receives the emergency number table before the terminal of the user registers with its home network. Thus, upon receiving a request from the local facility of the home network, it can immediately send the table to it.

According to another aspect of the development, the method comprises receiving a request for transmission of said table from the local facility and relaying said request to the visited network.

An advantage is that the table is not received systematically, but required when the local facility requests it.

The request from the local facility may be included in a specific message comprising a visited network identifier or inserted in an existing signalling message, such as a message requesting a visited network identifier.

The development also relates to a computer program product comprising program code instructions for implementing a method for providing a table according to the development, as described previously, when it is executed by a processor.

The development also relates to a computer-readable storage medium on which the computer programs as described above are recorded.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be streamed in particular on a network, for example the Internet network.

Alternatively, the storage medium can be an integrated circuit in which the program is embedded, the circuit being adapted to execute or to be used in the execution of the above-mentioned providing method.

The development also relates to a device for providing, by a communication network of a user of a terminal, referred to as home network, an emergency number table of another communication network, referred to as visited network, to which said terminal is attached, said table associating to emergency telephone numbers local to the visited network, uniform resource identifiers corresponding to said numbers, characterised in that the device is configured to implement in the home network at a control facility of network resources provided for the terminal:
obtaining said emergency number table in a signalling message received from the visited network following the attachment of the terminal of the user; and
transmitting said emergency number table to a local facility of the home network.

Advantageously, said device is configured to implement the above-mentioned providing method, according to its different embodiments.

Advantageously, said device is integrated into a control facility of network resources provided for the terminal of the user in the home network.

The above-mentioned corresponding control facility, providing device and computer program have at least the same advantages as those provided by the above-mentioned providing method according to the different embodiments of the present development.

Correlatively, the development also relates to a method of managing an emergency number table of a communication network, referred to as visited network, to which a user terminal of another communication network, referred to as home network, is attached, said table associating at least one emergency telephone number local to the visited network with a uniform resource identifier.

Said method is implemented by a mobility management facility of the terminal of the visited network and comprises storing said emergency number table and transmitting said table to the home network, following reception of a request for attachment of the terminal to the visited network.

According to the development, the facility in charge of the mobility of the terminal of the user in the visited network is configured to store and maintain an emergency number table of the visited network and to transmit it to the home network of the user terminal when the latter attaches to the visited network.

In this way, the home network dynamically obtains an up-to-date emergency number table.

This eliminates the need to implement a complex, time-consuming and error-prone static configuration. The handling of emergency calls from a terminal of the user in a mobile situation is therefore improved.

According to one aspect of the development, said table is transmitted in a signalling message comprising a request for the creation of a session for the terminal of the user with the home network.

An advantage is that this transmission is systematic as soon as the user requests to establish a multimedia session in a mobile situation in the visited network. The fact of pooling a signalling message that in any case would have been transmitted optimises the resources mobilised by signalling. It is noted that this multimedia session induces the establishment of a network session managed by the control facility.

According to another aspect of the development, said table is transmitted upon reception of a request from the home network, said request having been received following the transmission by the visited network of a registration request from the terminal of the user to the home network.

The emergency number table of the visited network is only transmitted when requested by the home network. The bandwidth resources are therefore saved.

The development also relates to a computer program product comprising program code instructions for implementing a management method of a table according to the development, as described previously, when it is executed by a processor.

The development also relates to a computer-readable storage medium on which the computer programs as described above are recorded.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be streamed in particular on a network, for example the Internet network.

Alternatively, the storage medium can be an integrated circuit in which the program is embedded, the circuit being adapted to execute or to be used in the execution of the above-mentioned management method.

The development also relates to a device for managing an emergency number table of a communication network, referred to as visited network, to which a user terminal of another communication network, referred to as home network, is attached, said table associating at least one emergency telephone number local to the visited network with a uniform resource identifier.

According to the development, said device is configured to implement in a mobility management facility of the visited network:

storing said emergency number table and transmitting said table to the home network, following a request to attach the terminal to the visited network.

Advantageously, said device is configured to implement the above-mentioned providing method, according to its different embodiments.

Advantageously, said device is integrated into a mobility management facility of a user terminal in the visited network.

The above-mentioned corresponding mobility management facility, the management device and computer program have at least the same advantages as those provided by the above-mentioned management method according to the different embodiments of the present development.

Correlatively, the development finally relates to a system for managing a registration request from a user terminal of a communication network, referred to as home network, said terminal of the user being attached to another communication network, referred to as visited network.

The system comprises said user terminal, the device for processing a registration request of a user terminal, the device for providing an emergency number table of the visited network and the device for managing an emergency number table of the visited network.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1 already described, illustrates the interfaces between different node facilities of a home network of a user terminal and a network visited by this terminal of the user according to a first architecture example;

FIG. 2 diagrammatically illustrates examples of the architecture of a local facility of the home network, said local facility integrating a device for processing a registration request to the home network from a user terminal according to an embodiment of the development, a control facility of network resources provided for the user terminal in the home network, said control facility integrating a device for providing an emergency number table of a network visited by the terminal of the user according to an embodiment of the development and facility for managing the mobility of a terminal of the user in the visited network integrating a device for managing an emergency number table local to the visited network according to a mode of implementation of the development.

FIG. 3 illustrates an example of an emergency number table associating local telephone numbers with a communication network, of uniform resource identifiers;

FIG. 4A and FIG. 4B describe in the form of a flowchart the steps of a method for processing a registration request from a user terminal of a communication network referred to as home network, said terminal of the user being attached to another communication network, referred to as visited network, according to embodiments of the development;

FIG. 5A, FIG. 5B, and FIG. 5C describe in the form of a flowchart the steps of a method for providing an emergency number table of a communication network visited by a user terminal of a home communication network, according to embodiments of the development;

FIG. 6A and FIG. 6B describe in the form of a flowchart the steps of a method for managing said emergency number table of a communication network visited by a user terminal of another communication network, referred to as home network, according to two embodiments of the development;

FIG. 7 describes in the form of a flow diagram the exchanges between the visited network and home network according to a first embodiment of the development;

FIG. 8 describes in the form of a flow diagram the exchanges between the visited network and the home network according to a second embodiment of the development;

FIG. 9 diagrammatically shows the interfaces between different node facilities of a home network of a user terminal and a network visited by this terminal of the user according to another architecture example;

FIG. 10 describes an example of a hardware structure of a device for processing a registration request from a user terminal of a home network, when attached to another communication network, referred to as visited network, according to the development;

FIG. 11 describes an example of the hardware structure of a device for providing an emergency number table of a communication network visited by a user terminal of another communication network, referred to as home network, said device being integrated into the home network, according to the development; and

FIG. 12 describes an example of the hardware structure of a device for managing an emergency number table of a communication network visited by a user terminal of another communication network, referred to as home network, said device being integrated into the visited network, according to the development.

### DETAILED DESCRIPTION OF CERTAIN ILLUSTRATIVE EMBODIMENTS

The general principle of the development is based on the management, in a communication network visited by a user terminal of another communication network, referred to as home network, both networks being interconnected, of an emergency number table associating uniform resource identifiers, accessible from the home network, with emergency telephone numbers local to the visited network. According to the development, this emergency number table managed and stored in the visited network is obtained by the home network, once the terminal of the user has attached to the visited network.

In this way, the home network has all the information necessary to establish an emergency call on request from the terminal of the user in a mobile situation.

This development is particularly interesting in the context of an IMS architecture and when the visited network and the home network are interconnected by an “S8hr” connection, according to which the signalling flows are routed by the same channel as the data streams. Indeed, in this context, any multimedia communication, in particular a VoIP voice communication, is completely managed by the home network.

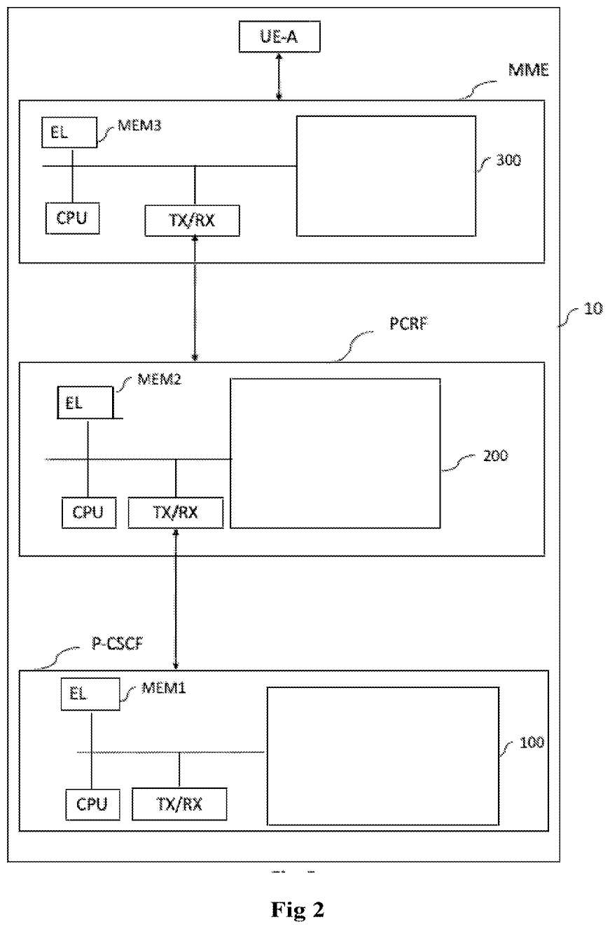

An example of the architecture of a local facility, which may be, for example, a P-CSCF (Proxy-CSCF (Call Session Control Function)) server located in the home network of a UE-A user terminal, according to an embodiment of the development, is now presented in relation to FIG. 2. In a known manner, such a facility constitutes the contact point of the UE-A user terminal belonging to the HPLMN home network with the control plan of the IMS system of this network, in charge of managing the signalling of multimedia services.

According to this embodiment of the development, the P-CSCF local facility comprises a device 100 for processing a registration request from the UE-A user terminal to the multimedia services of the home network according to the development, configured to receive this registration request from the UE-A user terminal and via the VPLMN visited network to which it has attached itself, and to obtain, on reception of this request, an emergency number table of a VPLMN visited network by the UE-A user terminal.

Advantageously, the device 100 is configured to send a request for transmission of the emergency number table to a control facility of the home network for relaying to the visited network, said control facility being configured to manage network resources provided for the terminal, and the device 100 further being configured to receive a response comprising said table.

According to an alternative, the device 100 is configured to check whether a said emergency number table is already available in the home network for the visited network and to issue such a transmission request when no table of correspondence is available or when the available table of correspondence is associated with an outdated validity indicator.

An example of an EL table is illustrated in FIG. 3. It associates local emergency numbers with uniform resource identifiers, for example of the URN type.

Advantageously, the device 100 is configured to store the emergency number table EL received in a non-volatile memory MEM1 local to the device 100 or remote in the home network.

Finally, the device 100 comprises a TX/RX module for receiving and transmitting messages from other facilities in the home network, such as for example the control facility mentioned above, which is here a PCRF (Policy Charging Rules Function) entity, configured, in a known manner, to control, in particular, the network resource necessary to transport the data streams, i.e. signalling and media, of the UE-A user terminal, as a function of predetermined rules and authorisations granted to the UE-A user terminal.

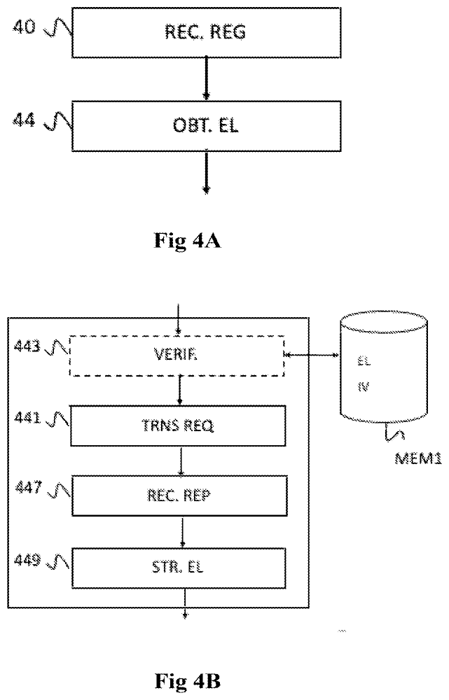

The device 100 thus implements the method for processing a request to register a user terminal according to the development that will be detailed hereafter in relation to FIGS. 4A-4B.

FIG. 2 also shows an example of the architecture of a control facility, such as for example here a PCRF entity according to an embodiment of the development. According to this embodiment of the development, the PCRF control facility comprises a device 200 for providing an emergency number table of a VPLMN communication network visited by the UE-A user terminal, configured to obtain said correspondence table in a signalling message received from the visited network following the attachment of the UE-A user terminal to this visited network and to transmit said emergency number table EL to the local facility (P-CSCF) of the home network.

Advantageously, the providing device 200 is configured to receive a transmission request for said table from the P-CSCF local facility and relay it to the VPLMN visited network.

Advantageously, the device 200 comprises a non-volatile memory MEM2 in which the emergency number table EL received from the visited network is stored. Finally, it includes a TX/RX module for receiving and transmitting messages from/to other facilities of the home network, such as the P-CSCF local facility or from/to the visited network.

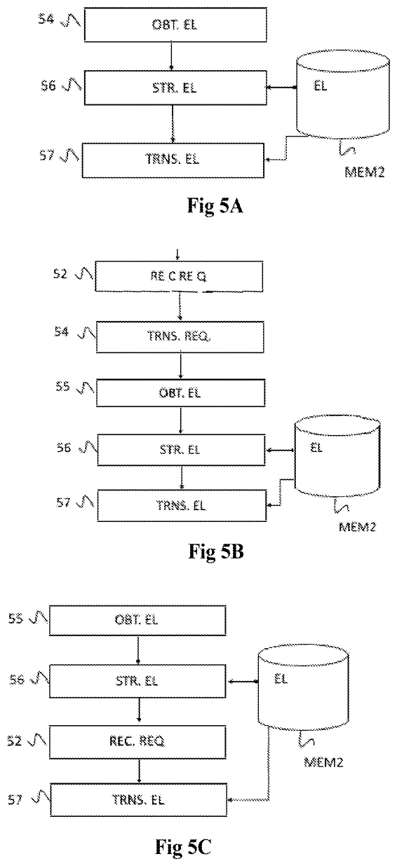

The device 200 thus implements the method for providing an emergency number table of a visited network according to the development that will be detailed hereafter in relation to FIGS. 5A-5C.

FIG. 2 also shows an example of the architecture of a control facility, such as for example here a Mobility Management Entity (MME) of the VPLMN visited network. In a known manner, this mobility management facility MME is the entry point into a 4G core network and is used to authenticate and manage the mobility of the UE-A user terminal when connecting to the visited network. It is also configured to select the S-GW and PGW communication gateways that will implement a default bearer communication channel between the UE-A user terminal and its home network. According to this example of an embodiment of the development, the mobility management facility comprises a device 300 for managing an emergency number table EL of the visited network, associating uniform resource identifiers, for example of the URN type, with telephone numbers local to the visited network.

Advantageously, it is also configured to receive from the home network of the UE-A user terminal a request to transmit the emergency number table EL and to transmit the list to it in response to this request.

Advantageously, the device 300 comprises a non-volatile memory MEM3 in which the emergency number table EL received from the visited network is stored. Alternatively, it is stored in a remote memory, which the device 300 can access.

Advantageously, the device 300 finally comprises a TX/RX module for receiving and transmitting messages to/from the home network and to/from the UE-A user terminal which has attached itself to the visited network.

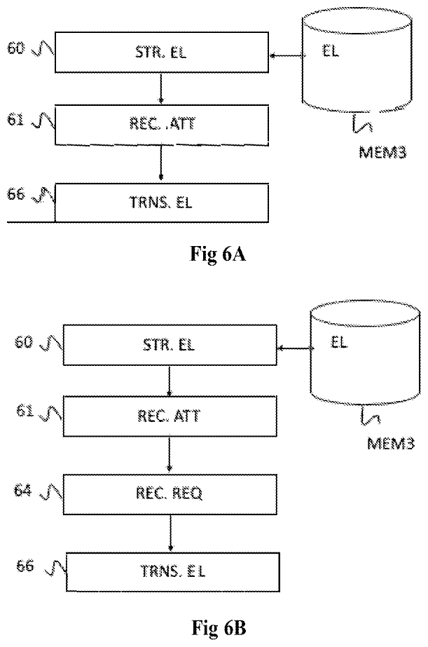

The device 300 thus implements the method for managing an emergency number table according to the development that will be detailed hereafter in relation to FIGS. 6A-6B.

Finally, FIG. 2 shows an example of the architecture of a system 10 for managing a registration request from a user terminal to its home network, when attached to a VPLMN visited network. Such a system comprises said UE-A user terminal, the P-CSCF local facility comprising the device 100 for processing a registration request of a user terminal, the PCRF control facility comprising the device 200 for providing an emergency number table of the visited network and the facility MME comprising the device 300 for managing an emergency number table of the visited network.

In relation to FIGS. 4A and 4B, embodiments of a method for processing a registration request from a user terminal, are now presented in the form of flowcharts, according to the development.

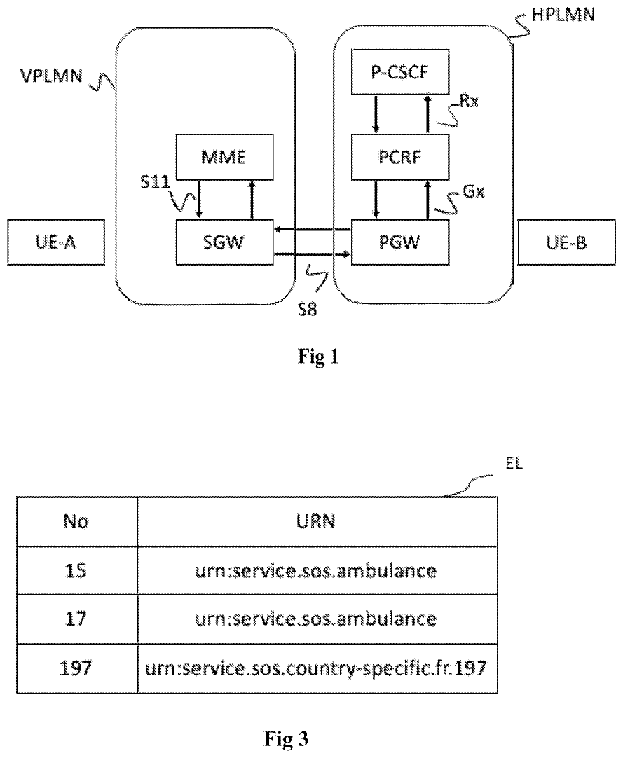

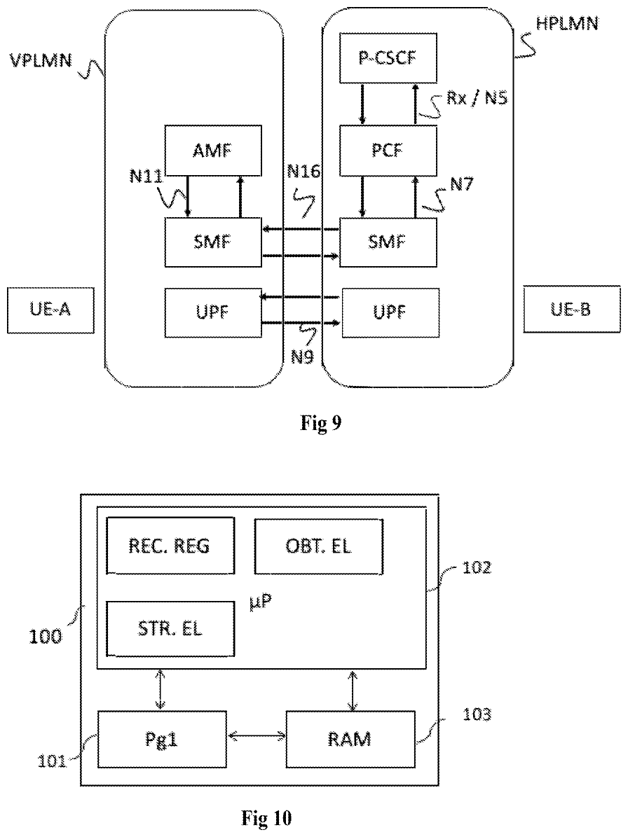

In these examples, the UE-A user terminal of a HPLMN home network is in a roaming situation and has attached itself to another communication network, the VPLMN visited network. This network is interconnected with the home network, for example by means of an “S8hr” connection as shown in FIG. 1. It is noted that the development is also applicable to other architectures, such as the one shown in FIG. 9, which shows an example of a 5GC architecture in which the two networks are interconnected by an interface N16 of the control plan, i.e. to carry signalling flows between the network entities, and an interface N9 of the user plan, that is to carry signalling flows of multimedia communications over IP, for example SIP, and media flows, e.g. voice.

For example, this process is implemented at a node facility of the home network, referred to as local facility, which constitutes for the UE-A user terminal the access point to the IMS services of this network. It is assumed that it is implemented by the device 100, which is integrated in a P-CSCF local facility of the HPLMN home network.

In relation to FIG. 4A, the device 100 receives in 40 a register request “Register” or REG from the terminal of the user. This request from the UE-A user terminal is to signal its presence to its home network, in particular the IMS system of this home network. This registration request is transparent to the VPLMN visited network which relays it to the HPLMN home network of the terminal like any other message, since it is the home network that is responsible for managing multimedia services for this terminal, in particular voice over IP calls.

In 44, the device 100 obtains an emergency number table EL (or “Emergency number table”) of the visited network. This list EL associates uniform resource identifiers, for example of type URN with telephone numbers local to the visited network, for example short numbers, as illustrated in FIG. 3 already described. Such URN identifiers are interpretable by any telecommunication network and are used to identify an emergency service so that it can be accessed from any network.

According to a first embodiment of the development illustrated in FIG. 4B, the obtaining step 44 comprises an optional step 443 of verifying a presence of such a list EL in memory. For example, the device 100 queries a database from a visited network identifier ID_VPLMN to obtain an emergency number table EL previously stored in memory, upon attachment to the VPLMN visited network of the UE-A user terminal or another user terminal. If it receives a positive response, it also checks, using a validity indicator IV associated with this table, if it is still valid or if it should be considered as obsolete. For example, this validity indicator is a counter or timer that the device 100 compares to a predetermined threshold. If its value is greater than the threshold, for example 24 hours, then the version of the list EL stored in memory is considered obsolete and the obtaining step 44 is performed.

If the value is below the threshold, the list EL is considered valid and there is no need to request a new version of the list EL from the visited network or other facility in the home network. Possibly, the device 100 can load the list into a more rapidly accessible memory, for example a local memory if the list EL was stored in a remote memory.

Otherwise, the device 100 triggers the step 441 of transmitting a request REQ for transmission of an emergency number table to a resource control facility provided for the terminal UE-A, belonging to the home network, for relaying to the visited network.

The relevant control facility in the home network is configured to manage the network sessions of the UE-A user terminal in the HPLMN home network of the terminal of the user.

The device 100 receives a response REP in 447, including the requested list EL. It stores it in memory in 449.

For example, the request REQ to transmit the emergency number table EL is transmitted in a specific message including the visited network identifier ID_VPLMN. For example, the message determined is a Diameter AAR information request including the identifier of the visited network and the request is expressed by inserting, in this message, a field representative of an action of a specific type, for example here, of the “Emergency number table” type.

According to a second embodiment of the development, the device 100 does not check if it already has an emergency number table in memory for the network visited by the UE-A user terminal, but systematically requests it in 441 and therefore does not need to know the identifier of the visited network beforehand. For example, its request REQ for transmission of the emergency number table EL is inserted in a request message for transmission of a visited network identifier. This message is usually sent by the local facility to the control facility following reception of the REG registration request. This is, for example, a Diameter AAR information request comprising a first field representative of a “PLMN-CHANGE” action, known per se, and a second field representative of an “Emergency-List” action as mentioned above.

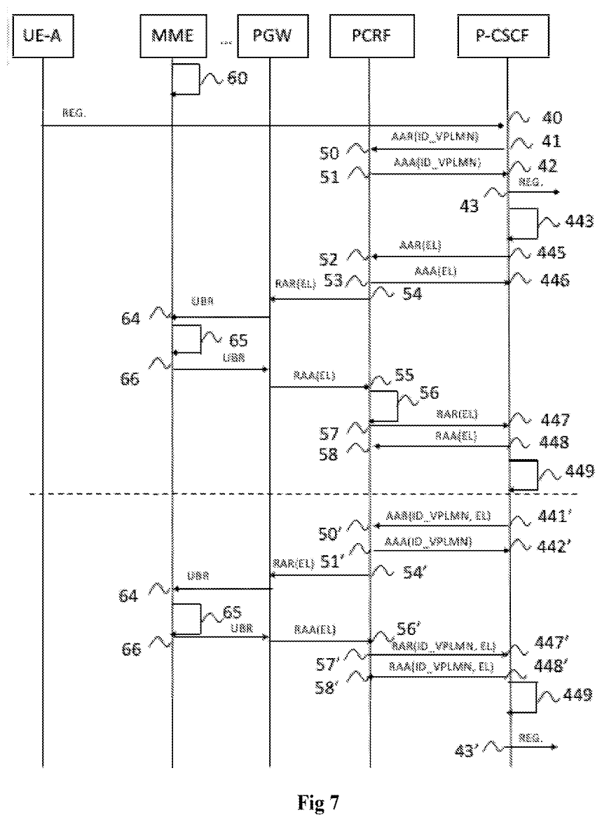

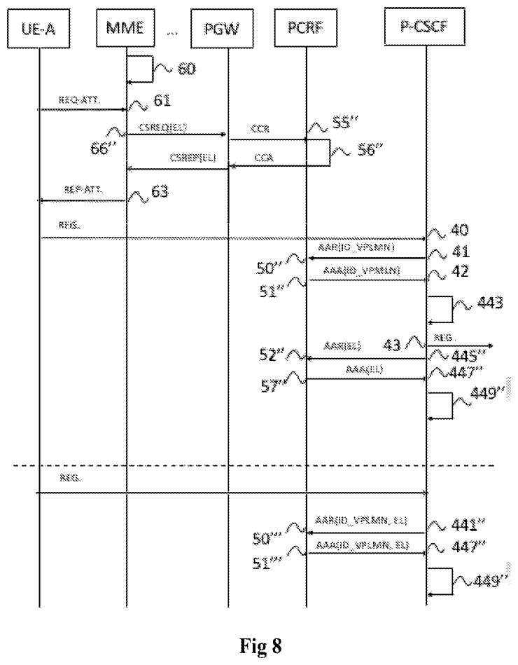

Some embodiments will be detailed hereafter in relation to FIGS. 7 and 8.

Examples of the implementation of a method of providing a communication network, referred to as home network, with an emergency number table of a communication network visited by UE-A user terminal of the home network, according to the development, are now presented in relation to FIGS. 5A-5C, in the form of flowcharts. For example, this method is implemented by the device 200, which is integrated in a PCRF control facility of the HPLMN home network.

In relation to FIG. 5A, the device 200 obtains in 54 an emergency number table EL from the mobility management facility 300 of the terminal UE-A (which is here integrated in an MME entity) of the VPLMN visited network. It stores it in 56 in a memory MEM2 local to the device 200 (for example a memory of the PCRF entity of the home network) or remote, and transmits it in 57 to the P-CSCF local facility.

According to a first embodiment of the development illustrated by FIG. 5B, the device 200 receives beforehand in 52 a request for transmission of the emergency number table of the visited network from the P-CSCF local facility, which it relays in 54 to the visited network.

On reception of a response from the visited network comprising the requested emergency number table EL in 55, it stores it in memory (MEM2) in 56 and retransmits it to the local facility in 57.

According to a second embodiment illustrated in FIG. 5C, the device 200 receives the emergency number table EL of the visited network in 55 before receiving a request to transmit this list from the P-CSCF local facility in 52. For example, it receives the list EL in a Diameter CCR (Credit Control Request) signalling message including a Diameter session creation request to process a registration request of the terminal UE-A. The sending of this request by the visited network is triggered by the reception of a request to attach the UE-A user terminal to the visited network and is part of the attachment procedure. As a reminder, the REG registration request mentioned above is only issued by the UE-A user terminal once the attachment procedure to the visited network is completed. Device 200 relays the emergency number table to the P-CSCF local facility in 57.

It is noted that in both of these embodiments, the PCRF reuses the same Diameter session (Session-ID) to respond to the P-CSCF local facility as was used to transmit the initial request. The endpoints (source and destination) of the session do not change, which ensures that the PCRF entity responds to the requesting P-CSCF.

Some embodiments will be detailed hereafter in relation to FIGS. 7 and 8.

In relation to FIGS. 6A and 6B, embodiments of a method for managing an emergency number table in a telecommunications network are now presented in the form of flowcharts, according to the development. In these examples, the method is implemented by the device 300. Advantageously, this device 300 is integrated in a node facility of the network visited by the UE-A user terminal, for example an MME facility for managing the mobility of user terminals.

According to a first embodiment, described in relation to FIG. 6A, in a step 60, the device 300 obtains the emergency number table EL of the visited network and stores it in memory MEM3. In 66, it transmits said table to the home network, following the reception in 61 of a request for attachment of the UE-A user terminal to the visited network. For example, the device 300 transmits it during the attachment procedure in a signalling message comprising a session creation request sent to the home network. This message is received in particular by the PCRF control facility of the home network.

According to a second embodiment described in relation to FIG. 6B, steps 60 and 61 are unchanged. In 64 it receives a request from the home network to transmit the list EL, to which it responds in 66.

Some embodiments will be detailed hereafter in relation to FIGS. 7 and 8.

In relation to FIG. 7, the exchanges of messages between the UE-A user terminal, the mobility management facility MME of the VPLMN network visited by the UE-A user terminal, the PCRF control facility of the HPLMN home network of the UE-A user terminal, and the P-CSCF local facility of the HPLMN home network, are now presented in the form of a flow diagram, according to a first embodiment of the development.

The UE-A user terminal sends a registration request, of the SIP Register type, from a VPLMN visited network, which retransmits it transparently to the HPLMN home network of this terminal. It is received in 40 by the P-CSCF local facility. On reception, the P-CSCF sends in 41 a Diameter AAR request to the PCRF control facility to request the identifier ID_VPLMN of the VPLMN visited network. As illustrated in FIG. 7, the interface between the P-CSCF and the PCRF is of the Diameter Rx type. This request includes a specific action of the type “Specific Action:PLMN-CHANGE”. The PCRF receives it in 50. It responds in 51 by sending a Diameter AAA response or a Diameter RAR (Re-Authorization Request) message comprising the 3GPP-SGSN-MCC-MNC Attribute Value Pair (AVP) elements used to identify uniquely the VPLMN visited network and particularly comprising the Mobile Network Code (MNC) and the Mobile Country Code (MCC) of the visited network. It is understood that according to this example the identifier ID_VPLMN of the visited network comprises two items of information which are the MNC identifier and the MCC identifier. The P-CSCF receives the identifier ID_VPLMN in 42. It should be noted that the steps just described are already standardised and are not part of the development.

In step 43 the P-CSCF relays the REGISTER message to the IMS core network, after inserting the identifier ID_VPMLN of the visited network in a header of this message.

In 443, the P-CSCF consults its local data to determine if it has the emergency number table EL associated with the VPLMN visited network identified by the identifier ID_VPLMN.

Advantageously, if it already has a version of the list EL, the P-CSCF determines if an update of this version is necessary. For example, as already described, it has a validity indicator IV associated with this version of the list EL and compares it to a predetermined threshold.

In particular, this indicator IV is a counter representative of a table TTL (Time To Live) lifetime that expires beyond a value corresponding to the predetermined threshold.

In the event that the P-CSCF has established in 443 that it was necessary to retrieve a new version of the emergency number table EL, the P-CSCF sends in 445 an AAR information request message to the PCRF on the Diameter Rx interface. According to the development, this message comprises a specific action of a new type, for example the “EMERGENCY-LIST” type by way of illustration.

The following is an example of this message:
Command Code: 265 AA
AVP: Session-Id val=1234
AVP: Auth-Application-Id val=3GPP Rx (16777236)
( . . . )
AVP: Specific-Action val=EMERGENCY-LIST

The PCRF receives this request in 52, acknowledges it in 53 and extends the request in 54 to a PGW gateway facility of the HPLMN home network via a Diameter Gx interface known to those skilled in the art.

An example of a Re-Authorization Request (RAR) message corresponding to this request is shown below:
Command Code: 258 Re-Auth
AVP: Session-Id val=4321
AVP: Auth-Application-Id val=3GPP Gx (16777238)
( . . . )
AVP: Event-Trigger val=EMERGENCY-LIST

As shown in FIG. 7, the PGW gateway of the HPLMN home network is connected to an SGW gateway of the VPLMN visited network via an S8 interface. On reception of the previous message, it inserts the received request in an “Update Bearer Request” message to the SGW gateway of the network VPLMN on the S8 interface by using the GTPv2 protocol as follows:
GPRS Tunneling Protocol V2
Message Type: Update Bearer Request (97)
( . . . )
Emergency number table IE

According to the development, the structure of this message is modified to include a new item of information IE (for example Emergency number table) which specifies a request for information about the emergency number table EL of the VPLMN visited network.

On reception, the SGW gateway of the visited network retransmits the request to a mobility management facility MME of the visited network. These two devices are interconnected via an S11 interface. For example, the message sent to the MME by the SGW gateway is GTP v2 compliant.

The MME receives the message in 64. In 65, it searches for the requested emergency number table EL from memory and inserts it into a response message which it transmits to the SGW in 66. According to the development, this message comprises a new “Emergency number table” item of information (IE) which contains the data of the list EL. For example, this response message conforms to the GTP v2 protocol:
GPRS Tunneling Protocol V2
Message Type: Update Bearer Response (98)
( . . . )
Emergency number table={(15,urn:service:sos.ambulance); {17, urn:service:sos.police); (196,urn:service:sos.country-specljicfr.196)}

This message is forwarded by the SGW gateway of the visited network to the PGW gateway of the HPLMN home network via the S8 interface. On reception, the gateway PGW retranslates the SGW response into a Diameter RAA message on the Diameter Gx interface, which contains the data from the list EL or an AVP “Emergency-List” item enhanced with the data from the list EL, as illustrated below:
Command Code, Response: 265 AA
AVP: Session-Id val=1234
AVP: Auth-Application-Id val=3GPP Rx (16777236)
( . . . )
AVP: Specific-Action val=EMERGENCY-LIST
AVP: Emergency-List val={(15urn:service:sos.ambulance); {17,urn:service:sos.police); (196,urn:service:sos.country-specificfr.196)}

The PCRF receives this message in 55, extracts the list EL from the message and stores it in memory in 56. It then retransmits the list EL in 57 in a Diameter RAR message in the AVP “Emergency-List” item to the P-CSCF as shown below:
Command Code, Response: 258 Re-Auth
AVP: Session-Id val=4321
AVP: Auth-Application-Id val=3GPP Gx (16777238)
AVP: Emergency-List val={(15,urn:service:sos.ambulance); {17,urn:service:sos.police); (196,urn:service:sos.country-specific.fr.196)}

Finally, in 447, the P-CSCF receives the list EL requested in the RAR message and acknowledges reception in 448. It updates or creates its local data in 449 from the received table.

Alternatively, the P-CSCF requests the identifier ID_VPLMN of the VPLMN visited network as well as the emergency number table EL in a single request, e.g. Diameter AAR, which it sends to the PCRF in 441′. Thus, it only queries the PCRF once. In this case, steps 445, 446 are omitted. The table is systematically updated with each new record. In this variant, the P-CSCF does not check if a version of the emergency number table is available in memory, as it does not yet know the identifier of the VPLMN visited network, nor does it use a timer. The PCRF already has the identifier ID of the visited network and uses this identifier to query in 54′ the MME facility of the VPLMN visited network to obtain its emergency number table EL. Note that the PCRF sends a Diameter RAR request which is first received by the PGW of the visited network. On reception, the PGW transforms the Diameter request received into a GTPv2 Update Bearer Request (UBR) which it transmits to the MME. The MME responds by inserting the requested list EL in a GTPv2 response message to the PGW. On reception, the PGW inserts the response in a Diameter RAA message to the PCRF which receives it in 56′ and redirects it to the P-CSCF in 57′.

Note that in this variant, the registration request can be redirected in 43′ to the IMS core network of the home network upon reception of the identifier ID_VPLMN of the visited network with the emergency number table EL in 448′ in the Diameter AAA response message.

In relation to FIG. 8, the exchanges of messages between the UE-A user terminal, the mobility management facility MME of the VPLMN network visited by the UE-A user terminal, the control facility P-CRF of the home network of the terminal of the user, and the P-CSCF local facility of the home network of the terminal of the user, are now presented in the form of a flow diagram, according to a second embodiment of the development.

On reception of a request to attach the UE-A user terminal to the VPLMN visited network in 61 by the MME, the latter sends in 66″ a connection request to the PGW access point of the home network of this terminal of the user. This connection request is, for example, inserted in a GTPv2 protocol compliant session creation request message, that is a “Create Session Request” message which transits via the SGW gateway of the visited network, then the interface S8 with the PGW gateway of the HPLMN home network. According to this embodiment of the development, this message comprises a new IE “Emergency number table” item of information which contains the data of the emergency number table EL. This message takes the following form, for example:
GPRS Tunneling Protocol V2
Message Type: Create Session Request (32)
( . . . )
Emergency
number table={(15,urn:service:sos.ambulance); {17,urn:service:sos.police); (196,urn:service:sos.country-specific.fr.196)}

The PGW gateway transmits the received session creation request to the PCRF in a “Diameter CCR” message (Credit-Control Request), including the list EL in an “Emergency-List” AVP item of information.

For example, this message is written as follows:
Command Code, Request: 272 CC
AVP: Session-Id val=1234
AVP: Auth-Application-Id val=3GPP Gx (16777238)
( . . . )
AVP: Emergency-List val={(15,urn:service:sos.ambulance); (17,urn:service:sos.police); (196,urn:service:sos.country-specific.fr.196)}

The PCRF receives this message in 55″ and stores the list EL in 56″.

Note that the PCRF responds to this CCR request with a CCA (Credit Control Answer) message comprising the rules for creating the default bearer channel.

On reception of a registration request in 40, for example of the SIP REGISTER type, from the UE-A user terminal, the P-CSCF requests the PCRF for the identifier of the visited network in 41, as already described in relation to FIG. 7. For example, it sends it a Diameter AAR message including the specific action “Specific-Action PLMN-CHANGE”. The PCRF sends in 51″ a type AAA response comprising the identifier ID_VPLMN of the VPLMN visited network. It is received in 42 by the P-CSCF. In 443, the P-CSCF uses the received identifier ID_VPLMN to check if an emergency number table is available in memory for the visited network. If so, it advantageously verifies if it is not obsolete, using a validity indicator IV, as previously described. It also propagates the SIP REGISTER registration request in 43 to the core of the IMS network after inserting the identifier ID_VPLMN of the VPLMN visited network. It is noted in this respect that the development does not interfere with this standardised registration procedure.

If the P-CSCF has determined that no update of the emergency number table associated with the visited network was necessary, the method for obtaining the table according to the development is complete.

If, on the contrary, the emergency number table needs to be retrieved, the P-CSCF sends in 445″ an AAR message to the PCRF containing the new specific action “Specific-Action EMERGENCYLIST” to request the emergency number table EL of the visited network.

The PCRF receives this request in 52″. Since it has already received the list EL from the MME, it responds without delay to the P-CSCF in 57″ for example by inserting the requested list EL in a Diameter acknowledgement message. In this second embodiment, it is unnecessary to wait for the reception of a subsequent RAR message, as in the first embodiment described in relation to FIG. 7.

For example, this message is written as follows:
Command Code, Response: 265 AA
AVP: Session-Id val=1234
AVP: Auth-Application-Id val=3GPP Rx (16777236)
AVP: Emergency-List val={(15,urn:service:sos.ambulance); {17,urn:service:sos.police); (196,urn:service:sos.country-specific.fr.196)}

The P-CSCF receives this message in 447″ and updates its local data with the list EL received in 449″.

It should be noted that the variant to the first embodiment also applies to this second embodiment of the development.

According to this variant illustrated by the lower part of the diagram in FIG. 8, the P-CSCF requests in 441″ both the identifier ID_VPLMN of the visited network and the emergency number table EL associated with this visited network in a same Diameter AAR type request. This request is received in 50″ by the PCRF, which directly inserts the two items of information requested in 51″ in a response, for example of the Diameter AAA type. The P-CSCF receives the AAA message in 447″ and extracts the two items of information requested. It stores the emergency number table EL in 449″.

The examples described above relate to an LTE communication network architecture, referred to as a 4G network, according to which the HPLMN home network of the UE-A user terminal and the network VPLMN visited by this terminal interconnect according to an “S8hr” connection mode. Naturally, the scope of the development is not limited to this type of architecture, but more broadly encompasses any other communication network architecture in which the signalling and media data streams of the terminal of the user terminate in its home network. This is the case, for example, with the new 5GC core network architecture defined by the 3rd Generation Partnership Project (3GPP), as described in the document entitled “3GPP TS 23.501 V15.3: System Architecture for the 5G System”, version 15.3.0 Release 15 published by ETSI in September 2019.

According to this SBA (Service Based Architecture), illustrated in FIG. 9, an AFM facility of the VPLMN visited network is the equivalent of the MME, an SMF facility plays a role equivalent to the SGW/PGW gateways on the control plan, a UPF facility is the equivalent of the PGW access point on the user plan, and a PCF facility is the equivalent of the PCRF entity in the architecture shown in FIG. 1. The P-CSCF local facility can be found in this architecture. The Service Based Interfaces (SBI) between these new facilities and the protocols they implement, for example described in the document entitled “3GPP TS 29500 V16.6: Technical Realization of Service Based Architecture”, published by ETSI in December 2020, are the following:
the Rx Diameter interface between P-CSCF and PCF is maintained but it can also be replaced by an httpv2 interface also called N5;
the N16 interface between the SMFs of the visited network and the home network uses the http/2 protocol;
the N7 interface between PCF and SMF and the home network uses the http/2 protocol;
the N9 interface between the UPFs of the visited network and the home network uses the http/2 protocol.

The development described above is therefore immediately applicable to the architecture shown in FIG. 9. For example, the device 100 is integrated with the P-CSCF, the device 200 with the PCF and the device 300 with the AMF facility.

In relation to FIG. 10, an example of the hardware structure of a device 100 for processing a registration request from a user terminal according to the development, integrated into a local facility of the home network, comprising at least one reception module REC. REG of a registration request from the terminal, said registration request having been transmitted by the visited network, and a module OBT. EL for obtaining an emergency number table, said list associating emergency numbers local to the visited network with uniform resource identifiers is now presented. Advantageously, the device 100 further comprises a module STR. EL for storing the emergency number table in a memory and an indicator of the validity of said list.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 100 comprises a random access memory 103 (a RAM memory, for example), a processing unit 102 equipped for example with a processor and controlled by a computer program Pg1, representative of the reception and obtaining modules, stored in a read-only memory 101 (a ROM memory or hard disk, for example). At initialisation, the code instructions of the computer program are for example loaded into a random access memory 103 before being executed by the processor of the processing unit 102. The random access memory 103 can also contain an emergency number table associated with the VPLMN visited network, said table comprising entries each associating a uniform resource identifier with an emergency telephone number local to the visited network.

FIG. 10 only shows a particular one of several possible ways of realising the device 100, so that it executes the steps of the method for processing a registration request of a user terminal as detailed above, in relation to FIGS. 4A-4B, 7 and 8 in its different embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 100 is realised with a reprogrammable computing machine, the corresponding program (that is the sequence of instructions) can be stored in a removable (such as, for example, a USB flash drive, CD-ROM or DVD-ROM) or non-removable storage medium, this storage medium being partially or totally readable by a computer or a processor.

The various embodiments have been described above in relation to a device 100 integrated in a local facility, for example a P-CSCF server of the communication network of the terminal of the user, referred to as home network.

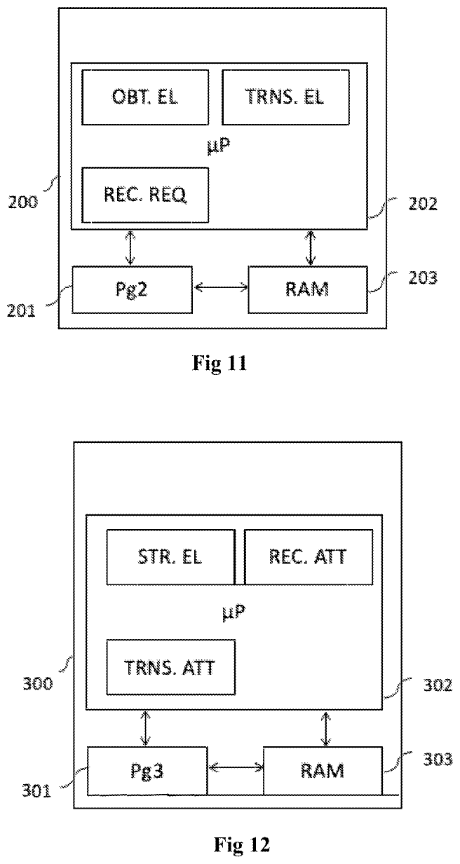

Next, in relation to FIG. 11, an example of the hardware structure of a device 200 for providing by a communication network of a user of a terminal, referred to as home network, an emergency number table of another communication network, referred to as visited network, to which said terminal is attached, said table associating to an emergency telephone number local to the visited network, a uniform resource identifier corresponding to said number, said device comprising at least one module OBT. EL for obtaining said emergency number table in a signalling message received from the visited network following the attachment of the terminal of the user and a module TRNS. EL for transmitting said emergency number table to a local facility of the home network is presented.

Advantageously, the device 200 also comprises a module REC. REQ for receiving a request for transmission of said table from the local facility and relaying said request to the visited network.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 200 comprises a random access memory 203 (for example, a RAM memory), a processing unit 202 equipped for example with a processor and controlled by a computer program Pg2, representative of the modules for obtaining, receiving, receiving a request for transmission and relay, stored in a read-only memory 201 (for example, a ROM memory or hard disk). At initialisation, the code instructions of the computer program are for example loaded into a random access memory 203 before being executed by the processor of the processing unit 202. The random access memory 203 can also contain an emergency number table, said table comprising entries each associating a uniform resource identifier with a telephone number of the visited network.

FIG. 11 only shows a particular one of several possible ways of realising the device 200, so that it executes the steps of the method for providing an emergency number table as detailed above, in relation to FIGS. 5A-5C, 7 and 8 in its different embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 200 is realised with a reprogrammable computing machine, the corresponding program (i.e. the sequence of instructions) can be stored in a removable (such as, for example, a floppy disk, CD-ROM or DVD-ROM) or non-removable storage medium, this storage medium being partially or totally readable by a computer or a processor.

Also, in relation to FIG. 12, an example of the hardware structure of a device 300 for managing an emergency number table of a communication network, referred to as visited network, to which is attached a terminal of a user of another communication network, referred to as home network, the list associating telephone numbers local to the visited network to uniform resource identifiers, said device comprising at least one module STR. EL for storing said table and a module TRNS. EL for transmitting said table to the home network, following the reception REC. ATT of a request to attach the terminal of the user to the visited network.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 300 comprises a volatile memory 303 (for example, a RAM memory), a processing unit 302 equipped for example with a processor and controlled by a computer program Pg3, representative of the storage and transmission modules, stored in a read-only memory 301 (for example, a ROM memory or hard disk). At initialisation, the code instructions of the computer program are for example loaded into a random access memory 303 before being executed by the processor of the processing unit 302. The random access memory 303 may also contain the emergency number table EL of the network visited by the terminal of the user.

FIG. 12 only shows a particular one of several possible ways of realising the device 300, so that it executes the steps of the processing method as detailed above, in relation to FIGS. 6A-6B, 7 and 8 in its various embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 300 is realised with a reprogrammable computing machine, the corresponding program (i.e. the sequence of instructions) can be stored in a removable (such as, for example, a floppy disk, CD-ROM or DVD-ROM) or non-removable storage medium, this storage medium being partially or totally readable by a computer or a processor.

The development that has just been described in its different embodiments has many advantages. In particular, it allows the home network of a mobile terminal of the user to obtain dynamically an emergency number table associated with the communication network visited by the terminal of the user. With the development, it is no longer necessary to configure statically in the home network all the emergency numbers of all the national networks to which the terminal of the user is likely to be attached, then to associate with them their transcription in a uniform resource identification format.

Thus the development contributes to optimising the roaming management of a terminal of the user, by avoiding errors in number entry by operators and by simplifying the creation and updating of tables. It also has the advantage of reusing the interfaces and protocols currently in use in current communication networks offering multimedia services over IP to their customers.

1. A method of processing a registration request from a user terminal of a communication network, referred to as a home network, the home network being configured to provide multimedia services to the terminal, the terminal being attached to another communication network, referred to as a visited network, interconnected with the home network, wherein the method is implemented at a local facility of the home network and in that the method comprises:
on reception of a registration request from the terminal of the user, the registration request having been transmitted by the visited network, obtaining an emergency number table of the visited network, the table associating with at least one emergency number local to the visited network a uniform resource identifier,
and in that the emergency number table being received from the visited network by the home network following reception of the registration request or a previous registration request from a user terminal attached to the visited network.

2. The method of processing according to claim 1, wherein obtaining comprises sending a request for transmission of the emergency number table to a control facility of the home network for relaying to the visited network, the control facility being configured to manage network resources provided for the terminal of the user, and receiving a response comprising the table.

3. The method of processing according to claim 2, wherein the method further comprises,
upon reception of an identifier from the visited network, checking that an emergency number table is already available in the home network for that identifier; and
sending the transmission request when no emergency number table is available or when the available emergency number table is associated with an out-of-date validity indicator.

4. The method of processing according to claim 3, wherein the request for transmission of the emergency number table is transmitted in a message comprising the identifier of the visited network.

5. The method of processing according to claim 2, wherein the request for transmission of the emergency number table is inserted in a request message for obtaining the identifier of the visited network, the message being transmitted following reception of the registration request of the terminal of the user by the local facility.

6. A method of providing in a communication network of a user terminal, referred to as a home network, an emergency number table of another communication network, referred to as a visited network, to which the terminal is attached, the table associating to at least one emergency telephone number local to the visited network, a uniform resource identifier corresponding to the number, uniform resource identifiers corresponding to the numbers, wherein the method is implemented in the home network by a control facility of network resources provided for the terminal and comprises:
obtaining the emergency number table in a signalling message received from the visited network following the attachment of the terminal of the user; and
transmitting the emergency number table to a local facility of the home network.

7. The method of providing according to claim 6, wherein the signalling message received from the visited network further comprises a request for the creation of a session for the terminal of the user.

8. The method of providing according to claim 6, wherein the method comprises, upon reception of a request from the local facility of the home network, transmitting the table to the local facility.

9. The method of providing according to claim 6, wherein the method comprises receiving a request for transmission of the table from the local facility and relaying the request to the visited network.

10. A method of managing a table of emergency numbers of a communication network, referred to as a visited network, to which a user terminal of another communication network, referred to as a home network, is attached, the table associating with at least one emergency number local to the visited network a uniform resource identifier corresponding to the number wherein the method is implemented by a mobility management facility of the terminal of the visited network and in that it comprises storing of the emergency number table and transmitting of the list to the home network, following receiving of a request for attachment of the terminal to the visited network.

11. The method of managing according to claim 10, wherein the table is transmitted in a signalling message comprising a request for the creation of a session for the terminal of the user with the home network.

12. The method of managing according to claim 10, wherein the table is transmitted upon reception of a request from the home network, the request having been received following the transmission by the visited network to the home network of a registration request from the terminal of the user.

13. A device for processing a registration request from a user terminal of a communication network, referred to as a home network, the home network being configured to provide multimedia services to the terminal, the terminal being attached to another communication network, referred to as a visited network, interconnected with the home network, wherein the device is configured to implement at a local facility of the home network:
on reception of a registration request from the terminal of the user, the registration request having been transmitted by the visited network, and obtaining of an emergency number table of the visited network, the table associating with at least one emergency number local to the visited network a uniform resource identifier corresponding to the number,
and in that the emergency number table being received from the visited network by the home network following reception of the registration request or a previous registration request from a user terminal attached to the visited network.

14. A device for providing by a communication network of a user of a terminal, referred to as a home network, an emergency number table of another communication network, referred to as a visited network, to which the terminal is attached, the table associating to at least one emergency number local to the visited network a uniform resource identifier corresponding to the number, wherein the device is configured to implement in the home network in a control facility of network resources provided for the terminal:
obtaining the emergency number table in a signalling message received from the visited network following the attachment of the terminal of the user; and
transmitting the emergency number table to a local facility of the home network.

15. A device for managing an emergency number table of a communication network, referred to as a visited network, to which a user terminal of another communication network, referred to as a home network, is attached, the table associating with at least one emergency number local to the visited network a uniform resource identifier corresponding to the number, wherein the device is configured to implement at a mobility management facility of the terminal of the visited network:
storing the emergency number table and transmitting the list to the home network, following reception of a request to attach the terminal to the visited network.

16. A system for managing a registration request for a user terminal to a communication network to which it is subscribed, referred to as a home network, the terminal of the user being attached to another communication network, referred to as a visited network, wherein the system comprises:
the terminal of the user,
a first device for processing a registration request from the user terminal according to claim 13,
a second device for providing an emergency number table of the visited network wherein the second device is configured to implement in the home network in a control facility of network resources provided for the terminal:
obtaining the emergency number table in a signalling message received from the visited network following the attachment of the terminal of the user; and
transmitting the emergency number table to the local facility of the home network, and
a third device for managing an emergency number table of the visited network wherein the third device is configured to implement at a mobility management facility of the terminal of the visited network:
storing the emergency number table and transmitting the list to the home network, following reception of a request to attach the terminal to the visited network.
